(19) United States
(12) Patent Application Publication
(10) Pub. No.: US 2018/0317408 A1
(43) Pub. Date: Nov. 8, 2018

(54) PLANT GROWING STAND AND PLANT PRODUCT

(71) Applicant: Aqvainnova B.V., Vinkeveen (NL)

(72) Inventor: Maurizio CASTALDINI, Vinkeveen (NL)

(73) Assignee: Aqvainnova B.V., Vinkeveen (NL)

(21) Appl. No.: 15/773,849

(22) PCT Filed: Nov. 4, 2016
(86) PCT No.: PCT/NL2016/050772

§ 371 Date: May 4, 2018

(30) Foreign Application Priority Data
Nov. 6, 2015 (NL) 2015738

(51) Int. Cl. A01G 31/02; A01G 9/029

(52) U.S. Cl. CPC A01G 31/02; A01G 9/0293

(57) ABSTRACT

The invention is related to plant growth and in particular to a plant growing stand. In one aspect the invention provides a plant growing stand comprising a container in which a plant holding structure is arranged. The plant holding structure comprises a bottom support member for receiving a plant thereon and a side support member for supporting a shoot system of the plant. The invention in another aspect provides a plant product comprising such a plant growing stand and a plant.

The present invention relates to a plant growing stand for growth of a plant on a non-solid substrate containing a supporting body for supporting the plant, the supporting body comprising a container defining a chamber in the supporting body which container is open at a top of the supporting body and a plant holding structure arranged in the chamber for holding at least part of the plant in the chamber. The present invention moreover relates to a plant product comprising a plant held by a plant growing stand.

In addition to light, nutrients, space and environmental temperature, most plants require a good support to be able to grow. A support enables rooting of the plant, which allows the plant to uptake nutrients and water with its root system. Plants are usually grown on a natural substrate which in addition to a supporting function provides the needed nutrients or water to the plants. Various types of substrates are known for plant growth, such as for instance soil. Other types of the substrates include other kinds of solid substrates, such as rock wool, or non-solid substrates such as liquid substrates, e.g. as used in hydroponic cultivation, jellified substrates, e.g. agar, and even gaseous or vaporized substrates, e.g. as used in an aeroponic or fogponic cultivation. If plants are grown on non-solid substrates, an additional support is often necessary for the growth of the plant. For instance hydroponically grown plants are usually supported with an inert medium such as gravel or perlite, or with other supporting means such as strings or stakes.

A particularly used support for growing plants is a plant growing stand as described in the first paragraph. The plant growing stand comprises a supporting body for supporting the plant which supporting body comprises a chamber in which the plant may be provided. The chamber is defined by a container which is open at a top of the supporting body to allow a plant to be provided in the chamber. A suitable substrate or medium may be provided in the chamber to supply the plant of the necessary nutrients and water. The container, for instance a plant pot, provides support to the plant provided in the chamber, and may contain the substrate or medium provided in the chamber. Although a plant may be grown in such plant growing stand, it has as a drawback that the support provided by such container when growing a plant on a non-solid substrate is not optimal.

The present invention aims amongst others to provide a plant growing stand that overcomes this drawback.

In order to achieve this aim a plant growing stand of the type described in the first paragraph is according to the present invention characterized in that the plant holding structure comprises a side support member extending laterally from the container in the chamber for supporting a shoot system of the plant and a bottom support member for receiving the plant thereon, wherein the side support member defines an opening for the shoot system of the plant which opening is vertically aligned with the bottom support member and the bottom support member is arranged between the top and bottom of the supporting body to divide the chamber in a lower chamber section below the bottom support member and an upper chamber section above the bottom support member, the sections being in open communication to enable the plant provided on the bottom support member in the upper chamber section to grow with roots extending into the lower chamber section. A plant or a group of plants may be fittingly provided in the plant growing stand on top of the bottom support member. The bottom support member will carry the plant or group of plants as provided in the upper chamber section above the lower chamber section in which a suitable substrate or medium may be provided. The lower chamber section and upper chamber section are in open communication, for instance by means of openings provided in the bottom support member, so that a root system of the plant or group of plants provided in the plant growing stand may develop and or grow into the lower chamber section to uptake nutrients and water from the substrate or medium provided in the lower chamber section. The shoot system of the plant or group of plants is held upright by the side support member of the plant holding structure to maintain the plant in a growth enabling and aesthetically pleasing vertical position above the lower chamber section. The term member as used herein may comprise a single member, element or part or alternatively may comprise a plurality of members, elements or parts. A height distance between the bottom support member and the side support member is preferably such that mainly a lower stem section of the plant or group of plants provided on the bottom support member is supported by the side support member, whereas an upper stem section and most leaves and/or flowers of the plant, extend or grow through and above the open side of the container at a top of the supporting body. The particular height distance between the bottom support member and the side support member may be adapted accordingly to the particular type of plant to be provided in the plant growing stand.

In a particular embodiment of the plant growing stand according to the present invention the container is open at a bottom of the supporting body to allow substrate or medium to enter the bottom chamber section from below, for instance by placing the container in an amount of liquid medium. Preferably the plant growing stand when placed on a surface remains in open communication with the surroundings via the open bottom of the container to allow an exchange of substrate or medium between the lower chamber section and the surroundings. For instance by placing the plant growing stand in flowing liquid medium, the medium in the container will continuously be refreshed and enriched with nutrients.

The supporting body may consist of one integral body in that the container and plant holding structure are made out of one piece. However, in a preferred embodiment the plant growing stand according to the present invention is characterized in that the plant holding structure and container are separate body parts of the supporting body. Thus both parts may be produced independently using appropriate materials and manufacturing techniques for each part. For instance the container may be made of a strong and wear proof material or mix or plurality of materials for a reliable and durable product. The container may be a relatively simple element for quick and easy production. In a preferred embodiment the plant growing stand according to the invention is herein characterized in that the container comprises a generally cylindrical wall enclosing the chamber and more particularly in that the container at least mainly consists of such cylindrical wall. Such cylindrical wall, more particularly a ring, is easy to produce with adequate strength for carrying the plant holding structure provided with a plant or group of plants. The plant holding structure may be made of any suitable material for growing a plant thereon, for example a plastic. Particularly the material is selected from a material that stimulates and supports growth of a root system of the plant. The plant holding structure, and in particular the bottom support member, may be designed, treated or prepared, for instance be coated or provided with a roughened surface, to enhance adherence of roots of the root system to the plant holding structure to improve an anchoring of the plant or group of plants to the plant growing stand. It is particularly advantageous if the plant develops and grows a root system with roots intertwining with each other and parts of the bottom support member and plant holding structure. The plant or plurality of plants growing in the growing stand will accordingly fixate to the plant holding structure which will minimize or prevent the plant from getting detached from the plant growing stand. Thus the plant growing stand is also particularly appropriate for use in transportation of a plant or group of plants provided in the stand.

In a further preferred embodiment the plant growing stand according to the present invention is characterized in that the container or generally cylindrical wall is transparent. The transparent wall allows for an unobstructed visual inspection of the container so that when a plant or group of plants is provided in the plant holding structure a root system thereof in the chamber may be seen. As such the root system may be inspected to determine whether the plant is healthy or potentially diseased or that the root system contains infectious agents or other unwanted contaminations which may affect the quality of the plant or plants. In particular it may be possible to determine whether the plant corresponds to or satisfy local or international rules and regulations with respect to living matter, particularly the import of living plants.

A further preferred embodiment of the plant growing stand according to the present invention is characterized in that the plant holding structure comprises a coupling member with which the plant holding structure is detachably coupled with the container. As such the plant holding structure and container may be easily taken apart without affecting an integrity of either part. For instance the plant holding structure and/or container may be used more than once. The container and plant holding structure are preferably coupled in such a way that the container can be removed without affecting a plant or group of plants provided in the plant holding structure. For instance the plant or group of plants held in the plant holding structure may conveniently be transported with the plant holding structure coupled to the container to enable the plants to uptake nutrients and/or water during transport from a substrate or medium provided in the container. However the container may be removed from the plant holding structure at any time as desired without affecting, particularly damaging, the plant or group of plants provided in the plant holding structure. The plant may also be taken out of or removed from the plant holding structure if desired, for instance for planting of the plant in another suitable environment with supporting substrate.

A further preferred embodiment of the plant growing stand according to the present invention is characterized in that the coupling member comprises an edge part of the plant holding structure extending laterally over a top edge of the container. The plant holding structure thus supports on the top edge of the container, which allows for an easy separation of the plant holding structure and the container simply by lifting the plant holding structure from the container.

In a further preferred embodiment the plant growing stand according to the present invention is characterized in that the edge part comprises a tab extending laterally beyond the top edge of the container. The tab may be used as a means for a user to grab on to manually lift the plant holding structure from the container. Alternatively or additionally the tab may constitute a coupling means in order to enable coupling of a label or other indicator with corresponding coupling means to the plant growing stand. For instance the tab may be shaped to connectively be received in a matching opening or recess provided in the label or other indicator. Such label or indicator may provide useful information to the user, such as the type of plant kept therein or particulars of said plant such as growing needs and maintenance information thereof. The information may for example describe the genus or species of plant, an international article number (EAN code), information for maintaining the plant such as pH, KH and temperature, and level of difficulty of planting and maintaining the plant involved.

In a further preferred embodiment the plant growing stand according to the present invention is characterized in that the plant holding structure defines a cup shaped basket with the bottom support member forming a base of the basket and the side support member extending laterally inward from the basket in the upper chamber section above the support member. A particular embodiment of the plant growing stand according to the present invention is characterized in that the cup shaped basket in a vertical direction tapers outward from the bottom support member to an edge extending over a top edge of the container. The tapering of the basket enables easy fitting of the basket in the chamber defined by the container. As an edge of the basket is supported by the container top edge the basket will be kept at a height in the chamber with the bottom support member dividing the chamber in the upper chamber section and lower chamber section. A distance between the inside surface of the container and the bottom support of the basket provides for the open communication between the upper chamber section and lower chamber section, allowing roots of the plant or group of plants received on the bottom support member to grow into the lower chamber section. The distance between the inside surface of the container and the basket as a result of the tapering shape of the basket allows for sufficient space for the plant or group of plants received on the bottom support member to develop and grow a root system in both a downwards direction in the lower chamber section as well as in a lateral direction towards an up to the inside surface of the container. This is particularly useful if the type of plant in the plant holding structure is a species with particularly horizontally developing roots.

A further preferred embodiment of the plant growing stand according to the present invention is characterized in that the side support member extends from the edge of the basket. The edge and the side support member defining the opening above the bottom support form a top surface of the plant holding structure. A plant or group of plants provided in the plant holding structure and supported by the side support member will extend above such top surface of the plant holding structure and the container so that an upper part of said plant or group of plants is visible. The plant growing stand is thus suitable for displaying the plant or plants grown therein.

In a further preferred embodiment the plant growing stand according to the present invention is characterized in that the side support member comprises a plurality of flexible teeth extending laterally inward from the plant holding structure above the bottom support member. The teeth provide sufficient support to the plant while the flexibility thereof may enable a relatively easy access to the upper chamber section for providing a plant or group of plants in the plant holding structure. For instance the teeth may bent where needed to allow sufficient space for a plant or group of plants to be introduced in the plant holding structure. It is preferred that a deformation of the flexible teeth is elastically or reversible instead of plastically or irreversible, so that the plant holding structure may be reused in its original shape.

In a further preferred embodiment the plant growing stand according to the present invention is characterized in that the bottom support member and the edge are connecting by at least one flexible connecting member. Such flexible connecting member may deform outward towards the container wall to increase the available space defined by the plant holding structure to accommodate for further growth of the plant or plants provided in the chamber. Preferably a design and a material for the connecting member are adapted to each other such that a flexibility of the connecting member is so that the deformation occurs under pressure by plant growth but remains sufficiently strong to carry the plant or plants provided in the container. It is preferred that the deformation of the flexible connecting member is elastically or reversible instead of plastically or irreversible, so that the plant holding structure may be reused in its original shape.

A further preferred embodiment of the plant growing stand according to the present invention is characterized in that the at least one connecting member is connected to the edge in between two side support teeth. Such alternately positioning of the teeth and connecting members in the plant holding structure facilitates an easy production of the plant holding structure. For example a plastic plant holding structure may be manufactured in a suitable molding process.

In a further preferred embodiment the plant growing stand according to the present invention is characterized in that the bottom support member comprises a horizontal wall in which the openings between the lower chamber section and upper chamber section are provided. The bottom support member may be a horizontal wall or plate extending from an inside surface of the container and completely separating the upper chamber section and lower chamber section. The wall or plate in such embodiment comprises openings through which roots of the plant may grow in the lower chamber section. Alternatively the horizontal wall or plate may be sized smaller than a cross section surface area of the chamber at the height where the wall or plate is arranged. In that case the wall or plate may be provided without openings as roots of the plant may grow in between the container and the wall or plate. However if needed for better root development the wall or plate may be provided with openings which provide an alternative or additional space for growth of roots of the plant.

In a further preferred embodiment the plant growing stand according to the present invention is characterized in that the bottom support member comprises a conical base with a top surface for receiving a plant thereon and a lateral guiding surface sloping downward to an opposite bottom surface of the conical base for guiding roots of the plant to the openings between the lower chamber section and upper chamber section.

A further preferred embodiment of the plant growing stand according to the present invention is characterized in that the supporting body has a density higher than water. As such the supporting body when placed in a liquid will in most cases sink in the liquid without the need for additional weights. The plant growing stand is therefore suitable for growing a plant in a liquid medium, particularly for growing a plant partially or fully submerged in liquid medium, as for instance for growing water plants or aquarium plants. For instance the container, which represents the majority of the total weight of the plant growing stand, may be made of a material with a density substantially higher than water, such as glass or ceramic. In particular the container may be a transparent glass ring.

The present invention moreover relates to a plant product comprising a plant held by a plant growing stand. In a preferred embodiment of the plant product of the present invention the plant is a water plant, in particular an aquarium plant.

In a further preferred embodiment of the plant product according to the invention the plant and plant growing stand are packaged in a transparent holder. Preferably an amount of suitable substrate or medium, such as a liquid medium, may be contained by the holder in the plant product to provide nutrients and/or water to the plant. Such plant product may be stored, transported, and sold as such, wherein the plant remains visible at all times. A user, particularly an end user, may remove the transparent packaging when desired, for example to transfer the plant from the plant product to a natural or artificial habitat or environment. As an example the plant product may comprise an aquatic plant kept in a plant growing stand according to the invention which plant growing stand with aquatic plant is provided with a label with information on the plant and packaged in a sealed, transparent and liquid tight plastic packet or bag. A suitable liquid medium is also provided in the packet or bag to provide the plant with necessary nutrients and water for growth. The plant product may be stored as long as the liquid medium is rich in nutrients for a viability of the plant. The plant product may also be displayed to a public as an article for sale. The plant product is suitable for transportation as the plant is firmly kept and supported in the growing stand. The aquatic plant may be removed from one or more of the other elements of the plant product as desired. For instance the aquatic plant of the plant product may be taken apart for use in an aquarium.

These and other aspects of the present invention are further elucidated by the appended drawings and the corresponding embodiment, which form part of the present application. The drawings are not in any way meant to reflect a limitation of the scope of the invention, unless this is clearly and explicitly indicated.

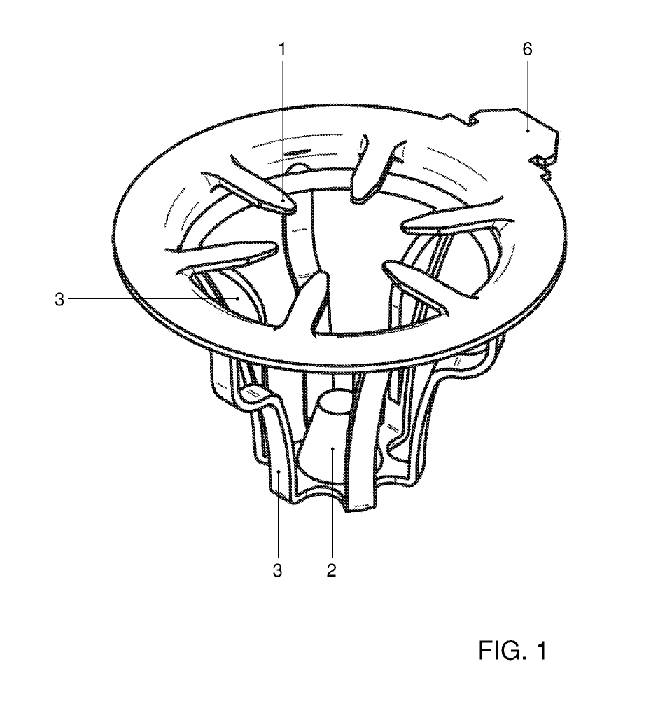

FIG. 1 shows an exemplary embodiment of a plant holding structure for use in a plant growing stand according to the invention.

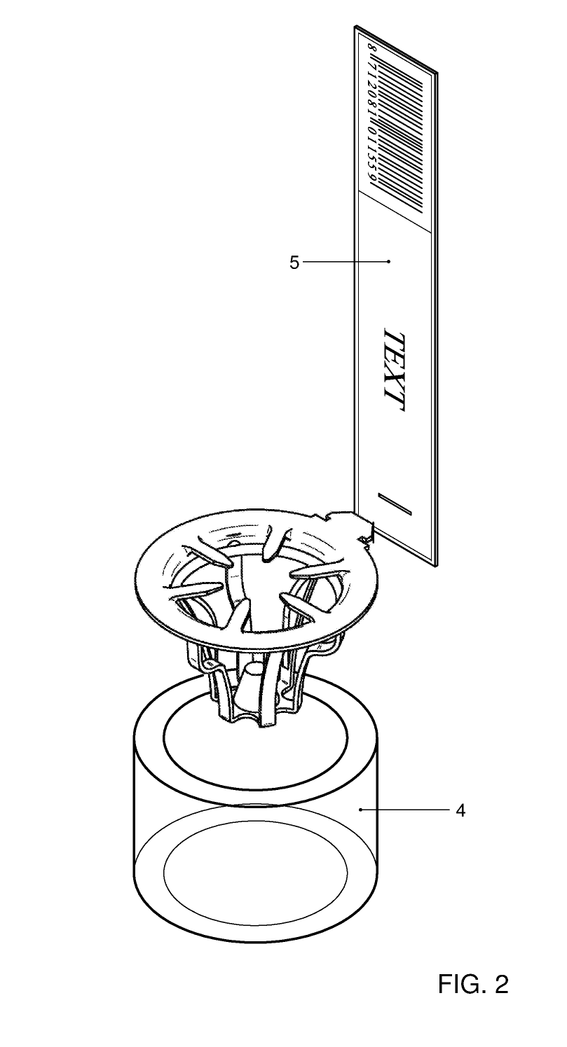

FIG. 2 shows the plant holding structure of FIG. 1, a container and a label for use in a plant growing stand according to the invention.

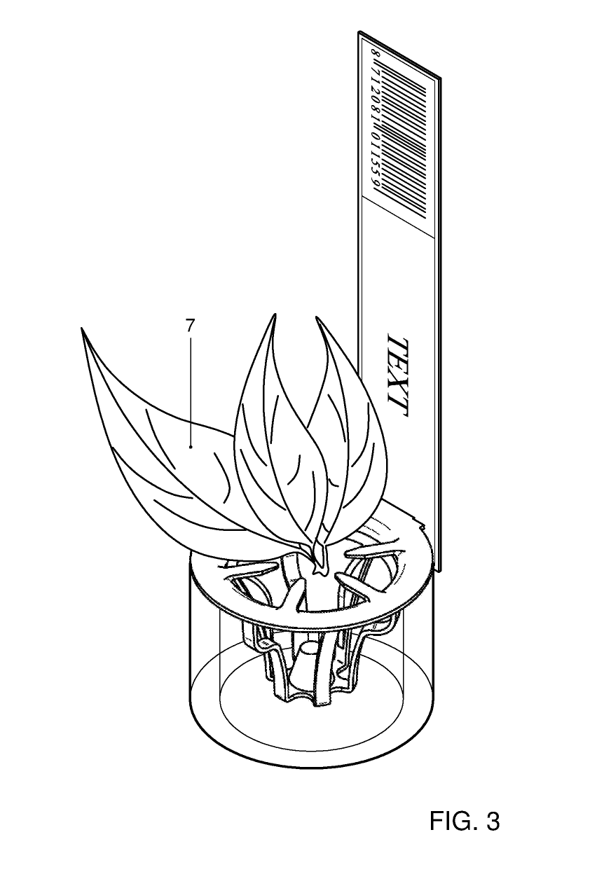

FIG. 3 shows the plant growing stand with the plant holding structure, container and label of FIG. 2 in assembled form.

As shown in FIGS. 1-3 the plant holding structure for use in a plant growing stand according to the invention comprises a side support member of laterally extending teeth 1 for supporting a shoot system of a plant or a plurality of plants 7 provided in the plant holding structure. The teeth define an opening for receiving the shoot system of the plant or plurality of plants. The opening is vertically aligned above a bottom support member 2 of the plant holding structure so that a plant received on top of the bottom support member 2 will be held in an at least almost vertical, upright, position by the bottom support member and side support member. The teeth of the side support member extend radially inward from an edge of the plant holding structure which extents over a top edge of the cylindrical shaped container 4. The edge, which is ring-shaped, is supported by the container so that the plant holding structure is carried by the container. As a height of the container is larger than a height of the plant holding structure, the bottom support member 2 is positioned in height between a bottom surface of the container and a top surface of the container. The bottom support member 2 divides a chamber defined by the container in an upper chamber section in which the plant holding structure is provided and a lower chamber section in which a root system of the plant or group of plants may grow. The lower chamber section may be filled with a plant growth substrate or medium, such as a liquid medium, for providing the necessary nutrients and liquid to the plant or group of plants for growth. The plant holding structure may also be placed over or in an amount of plant growth substrate or medium, as the container is open at a bottom for open communication between the lower chamber section and a surroundings.

The bottom support member 2 has a conical or pyramid shaped base with a top surface for receiving a plant thereon and a lateral guiding surface sloping downward to an opposite bottom surface of the conical base for guiding roots of the plant to the openings between the lower chamber section and upper chamber section.

The ring-shaped edge comprises a laterally extending tab 6 which extends laterally beyond the outside surface of the container 4. The tab may be dimensioned with an adequate surface area for a user to grab with its fingertips in order to position a plant holding structure on top of the container or vice versa in order to manually lift the plant holding structure from the container. The plant holding structure may be firmly coupled to the container by applying downward pushing pressure on the plant holding structure positioned on the container, which will force clamping means in the plant holding structure to fit in the chamber while engaging the container wall under clamping force.

The tab 6 may also be used to attach a label or other indicator 5 to the plant growing stand. Hereto the tab may comprise edges or shoulders that engage with corresponding edges or shoulders of the label or indicator at an opening or recess in the label or indicator for a snapping connection between the plant holding structure and the label or indicator. The label or indicator 5 may comprise an informative and/or aesthetic sign.

The ring-shaped edge with extending teeth and tab and the bottom support member are connected by connecting members 3 to render an integral plant holding structure made out of one piece. The plant holding structure is a plastic body which may be made with an appropriate and convenient molding technique. The plant holding structure represents a cup shaped basket with an open structure in between the connecting members 3 through which roots of the plant may grow. The connecting members 3 of the cup shaped basket taper from the bottom support member 2 outwards to the edge. Accordingly, the basket easily fits through the open top side of the container until the laterally extending ring-shaped edge of the basket engages the top surface of the container. As a circumference of the bottom support member is smaller than a circumference of the chamber defined by in inside surface of the container, there is sufficient space in between the bottom support member and the container for roots of the plant to grow into the bottom chamber section to uptake ingredients and liquid from a substrate or medium present in the bottom chamber section.

The connecting members 3 are sufficiently strong to carry the bottom support member on which a plant or group of plants is provided. The connecting members 3 are flexible in that a lower part of each connecting member coupled to the bottom support member may elastically deform outward under pressure by plant growth towards the container wall to increase the available space defined by the plant holding structure to accommodate for further growth of the plant or plants provided in the chamber. A flexible upper part of each connecting member coupled to the ring-shaped edge is staggered outward with respect to the lower part of the connecting member and forms a clamping means for a firm connection between the plant holding structure and the container. An imaginary circumferential dimension around the upper parts of all the connecting members is in the initial position in rest larger than the circumferential dimension of the chamber defined by the inside surface of the container. However by applying a slight downwards pressure on the plant holding structure the flexible upper parts of the connecting members will be forced radially inward, so that the plant holding structure below the ring-shaped edge will fit in the chamber however with the flexible upper parts of the connecting members clampingly engaging the inside surface of the container.

For the purpose of clarity and a concise description, features are described herein as part of the same or separate aspects and preferred embodiments thereof, however, it will be appreciated that the scope of the invention may include embodiments having combinations of all or some of the features described.

1. Plant growing stand for growth of a plant, containing a supporting body for supporting the plant, the supporting body comprising a container defining a chamber in the supporting body which container is open at a top of the supporting body and a plant holding structure arranged in the chamber for holding at least part of the plant in the chamber, characterized in that the plant holding structure comprises a side support member extending laterally in the chamber for supporting a shoot system of the plant and a bottom support member for receiving the plant thereon, wherein the side support member defines an opening for the shoot system of the plant which opening is vertically aligned with the bottom support member and the bottom support member is arranged between the top and bottom of the supporting body to divide the chamber in a lower chamber section below the bottom support member and an upper chamber section above the bottom support member, the sections being in open communication to enable the plant provided on the bottom support member in the upper chamber section to grow with roots extending into the lower chamber section.

2. Plant growing stand according to claim 1, characterized in that the plant holding structure and container are separate body parts of the supporting body.

3. Plant growing stand according to claim 1, characterized in that the container comprises a generally cylindrical wall enclosing the chamber.

4. Plant growing stand according to claim 3, characterized in that the generally cylindrical wall is transparent.

5. Plant growing stand according to claim 1, characterized in that the plant holding structure comprises a coupling member with which the plant holding structure is detachably coupled with the container.

6. Plant growing stand according to claim 5, characterized in that the coupling member comprises an edge part of the plant holding structure extending laterally over a top edge of the container.

7. Plant growing stand according to claim 6, characterized in that the edge part comprises a tab extending laterally beyond the top edge of the container.

8. Plant growing stand according to claim 1, characterized in that the plant holding structure defines a cup shaped basket with the bottom support member forming a base of the basket and the side support member extending laterally inward from the basket in the upper chamber section above the support member.

9. Plant growing stand according to claim 8, characterized in that the cup shaped basket in a vertical direction tapers outward from the bottom support member to an edge extending over a top edge of the container.

10. Plant growing stand according to claim 9, characterized in that the side support member extends from the edge of the basket.

11. Plant growing stand according to claim 10, characterized in that the side support member comprises a plurality of flexible teeth extending laterally inward from the plant holding structure above the bottom support member.

12. Plant growing stand according to claim 11, characterized in that the bottom support member and the edge are connecting by at least one flexible connecting member.

13. Plant growing stand according to claim 12, characterized in that the at least one connecting member is connected to the edge in between two side support teeth.

14. Plant growing stand according to claim 1, characterized in that the bottom support member comprises a horizontal wall in which the openings between the lower chamber section and upper chamber section are provided.

15. Plant growing stand according to claim 1, characterized in that the bottom support member comprises a conical base with a top surface for receiving a plant thereon and a lateral guiding surface sloping downward to an opposite bottom surface of the conical base for guiding roots of the plant to the openings between the lower chamber section and upper chamber section.

16. Plant growing stand according to claim 1, characterized in that the supporting body has a density higher than water.

17. Plant product comprising a plant held in a plant growing stand according to claim 1.

18. Plant product according to claim 17, wherein the plant is a water plant, in particular an aquarium plant.

19. Plant product according to claim 17, wherein the plant and plant growing stand are packaged in a transparent holder.
